(19) United States
(12) Patent Application Publication
(10) Pub. No.: US 2012/0265327 A1
(43) Pub. Date: Oct. 18, 2012

(54) DEVICE FOR RECORDING PARAMETERS OF A GOLF GAME

(75) Inventors: James Gerald BUCKLEY, Kerry (IE); Graham Daniel SPRING, Kerry (IE); George Anlos DANOS, London (GB)

(73) Assignee: James Gerald Buckley, Listowel (IE)

(21) Appl. No.: 13/420,077

(22) Filed: Mar. 14, 2012

Related U.S. Application Data
(63) Continuation of application No. 12/019,739, filed on Jan. 25, 2008, now abandoned.
Application No. 12/019,739 is a continuation of application No. 10/482,059, filed on Sep. 29, 2004, now abandoned.

(30) Foreign Application Priority Data
Jun. 25, 2001 (IE) 2001/0584

(51) Int. Cl. G06F 19/00

(52) U.S. Cl. 700/92

(57) ABSTRACT

A hand held device for recording scores of a golf game played by one or more players comprises a VDU which selectively displays reference fairways graphically, and which permits a player to enter the position of the location of a ball after each shot on the VDU by positioning a cursor at a position on the green or the reference fairway displayed on the VDU corresponding to the position of the ball on the fairway or green being played. A microprocessor stores a graphical representation of each reference fairway with the positions of the ball, which have been entered by the cursor on each fairway, in a RAM, and computes the number of shots to each hole. A score card for each player is displayed on the VDU. Graphical representations of each player's performance on each fairway can be reviewed after the game.

This application is a Continuation of U.S. application Ser. No. 12/019,739 filed Jan. 25, 2008, which application is a Continuation of U.S. application Ser. No. 10/482,059, filed Dec. 29, 2003; which is a 371 of PCT/IE02/00084 filed Jun. 25, 2002; which claims priority from Ireland Application No. S201/0584 filed Jun. 25, 2001, the disclosures of each which are incorporated herein by reference.

### BACKGROUND OF THE INVENTION

The present invention relates to a device for recording parameters of a golf game.

In general, when one is playing a game of golf, it is normal to record the scores on a card. The recordal of the scores of the golf game, in general, is carried out manually where one enters one's score on each hole played by writing the score on the card. While this method is quite adequate for the purpose of recording a player's score in a golf game, and for the purpose of determining the winner in a golf competition, it is not ideal for allowing a player to analyse a game subsequently. A player can only compare his or her score as written on the score card with the scores of other games which he or she may have played on the same course at earlier dates. Thus, in general, the only comparison which can be made is a comparison between the number of shots taken on each hole. This, while it does permit some degree of meaningful comparison, at the same time only provides a limited degree of comparison. It does not permit a player to analyse, for example, distances of drives, chips and putts which were played by the player on respective different games, nor does it permit a player to analyse the accuracy and the direction of his or her shots, for example, if the shots were on line with the hole or otherwise, if any of the shots ended up in the rough, in a sand bunker, a water hazard or the like.

There is therefore a need for a device for recording parameters of a golf game which overcomes at least some of these problems.

The present invention is directed towards providing such a device.

According to the invention there is provided a device for recording parameters of a golf game, characterised in that the device comprises a display means for displaying graphically a representation of a reference fairway, a means for indicating on the reference fairway a position indicative of a location taken up by a ball after a shot, a reading means for reading the indicated position, and a computing means responsive to the reading means reading an input which indicates that a ball has been holed for summing the number of indicated positions indicated on the reference fairway for determining the number of shots from a tee to a hole, and a first storing means for storing the determined number of shots from the tee to the hole.

In one embodiment of the invention a second storing means is provided for storing graphical representations of a plurality of reference fairways, the pars of the holes of which are different.

In another embodiment of the invention the graphical representations of the respective reference fairways differ depending on the par of the hole. Preferably, the means for displaying the graphical representation of one of the reference fairways is provided for selectively displaying a selected one of the reference fairways.

In one embodiment of the invention the display means displays a graphical representation of respective selected ones of the reference fairways for each of a number of holes to be played in the golf game.

In another embodiment of the invention the computing means computes the score of a round of golf, and the first storing means stores the score of a round of golf. Preferably, the first storing means stores the graphical representation of each reference fairway displayed for the respective holes with the indicated positions on the respective graphical representations of the reference fairways for each hole played.

In one embodiment of the invention the graphical representation of each reference fairway comprises a representation of a rough location. Preferably, the graphical representation of each reference fairway comprises an out of bounds location. Advantageously, the graphical representation of each reference fairway comprises a sand bunker location. Ideally, at least some of the reference fairways comprise a water hazard location.

In another embodiment of the invention the reading means reads the type of location in which the location taken up by the ball after a shot is indicated on the selected reference fairway. Preferably, the reading means determines from the indicated position the type of location in which the ball is indicated as being located after a shot. Advantageously, the reading means determines from the indicated position the lie of the ball to the left or right of a line joining the tee to the hole.

In one embodiment of the invention the graphical representation of each reference fairway indicates an area between a green and the tee which is within a predetermined distance from the green, and the reading means reads the indicated position for determining if the indicated location of the ball is within the predetermined area.

In another embodiment of the invention the second storing means stores a graphical representation of at least one reference green independently of the reference fairways. Preferably, the second storing means stores a plurality of graphical representations of reference greens, and the respective reference greens are stored in the second storing means cross-referenced with corresponding reference fairways.

In another embodiment of the invention the display means selectively displays a graphical representation of a reference green corresponding to each reference fairway displayed. Alternatively, the display means displays a reference green independently of each reference fairway.

In another embodiment of the invention the display means displays a reference green corresponding to a reference fairway independently of the reference fairway.

Preferably, the graphical representation of each reference green is provided with a plurality of bands of predetermined radial distance from and extending around a hole on the reference green for defining predetermined distances from the hole. Advantageously, the means for indicating the position indicative of a location taken up by a ball is provided for indicating the position relative to the hole taken up by the ball on the selected reference green.

In one embodiment of the invention the means for indicating the position indicative of a location taken up by a ball after a shot on the selected one of the selected reference fairway or the selected reference green is provided by a cursor.

In another embodiment of the invention the visual display means comprises a touch sensitive screen.

In a further embodiment of the invention the means for indicating the position indicative of a location taken up by a ball after a shot on the selected one of the selected reference fairway or the selected reference green is provided by a means for reading the position on the screen on which the screen is externally touched.

In one embodiment of the invention a first input means is provided for inputting a message indicating a lost ball. Preferably, a second input means is provided for inputting a message indicating a penalty. Advantageously, a third input means is provided for indicating that the position taken up by a ball after a shot is within a water hazard. Ideally, the computing means is responsive to the first, second and third input means for computing the score of a round of golf.

In another embodiment of the invention a data input means is provided for facilitating selective inputting of particulars of any one of the following characteristics of a player about to play a golf game, and of the golf course on which the golf game is to be played, namely,
the handicap of the player,
parameters of the course,
particulars of the tees being played, course conditions on the day the game is being played,
weather conditions on the day the game is being played, and
condition of the player on the day the game is being played.

Preferably the data input means permits inputting of the number of holes in the golf course, the yardage of each hole, the par of each hole and the index of each hole. Preferably, the first storing means stores data inputted through the data input means.

In one embodiment of the invention the computing means computes the score for each hole less the handicap of the player.

In another embodiment of the invention the computing means compares the player's score for each hole against the par and/or index of the hole.

In a further embodiment of the invention an output means is provided for outputting the score for each hole played and the score for the round played. Preferably, the output means facilitates outputting the score of the front nine holes and the back nine holes separately of each other. Advantageously, the output means interfaces with the display means for displaying the respective scores on the display means.

In one embodiment of the invention the scores are displayed on the display means in tabular form.

In a further embodiment of the invention the computing means is adapted for selecting the holes of each of the holes played on a particular golf course over a number of games on which the player achieved the best hole scores, and displaying the scores of the selected ones of the holes in tabular form as a “dream game”.

In a still further embodiment of the invention the computing means is adapted for selecting the holes of each of the holes played on a particular golf course over a number of games on which the player achieved the worst hole scores, and displaying the scores of the selected ones of the holes in tabular form as a “nightmare game”.

Preferably, the device is a hand held device.

Advantageously, the device comprises an interface means for interfacing the device with an external computer for downloading data in respect of each game to the external computer.

Additionally, the invention provides a method for recording parameters of a golf game, wherein the method comprises the steps of displaying a graphical representation of a reference fairway on a visual display means, indicating on the reference fairway a position indicative of a location taken up by a ball after a shot, reading the indicated position by a reading means, summing the number of indicated positions indicated on the reference fairway for determining the number of shots from a tee to a hole in a computing means, and storing the determined number of shots from the tee to the hole in a first storing means.

In one embodiment of the invention the graphical representation of each reference fairway displayed for the respective holes with the indicated positions on the respective graphical representations of the reference fairways for each hole played is stored in the first storing means.

### SUMMARY OF THE INVENTION

The advantages of the invention are many. A particularly important advantage of the invention is that by virtue of the fact that the golf games played by a player are recorded in graphical form, and in particular, by virtue of the fact that the position taken up by the ball after each shot is also recorded in graphical form, a player can analyse the graphical representation of his or her play for each hole subsequent to playing the game, and indeed, can compare graphical representations of his or her play on the same hole or holes over a number of games. Accordingly, a player by analysing the graphical representations of his or her game can identify weaknesses in his or her game, and by so identifying the weaknesses can correct his or her game, and can also identify weaknesses where further practice is required in order to improve the player's game and his or her performance. Additionally, the device and the method according to the invention permits simple and easy entry of the position of a ball after each shot by a player. There is no need for the player to measure the distance, all that is required is to indicate graphically on the graphical representation of the selected reference fairway the position of the ball after each shot. Thus, a player need not physically measure the distance travelled by a ball after each shot and record it manually. A further advantage of the invention is that it permits ready graphical display of a player's play for each hole of any particular game played by a player, and furthermore, graphical representations of the play for each hole of many games played by one or more players can be stored in the device for subsequent recall. Additionally, the games can be stored under any suitable classification system, for example, by name of person, course, the date played or by any other suitable means. A player may also use the device to enter a game played by a professional on a particular course, and compare his or her game with that of the professional.

The device and method according to the invention also permits ready computing of each player's score for a number of players playing in a game of golf, for example, the scores and graphical representations of the play for each hole of the players of a “two ball”, a “three ball”, a “four ball”, or the like can be readily computed and stored. Furthermore, the scores and indeed the graphical representation of the play for each of the holes of each of the players can be stored for subsequent downloading to a computer, such as a club computer or a national or international base server for determining the winner, runner-up, etc. of a golf competition.

The device and method according to the invention as well as permitting a visual analysis of a player's golf game, may also be used for entertainment purposes, whereby a player could enter a fictitious game, or could play and score an actual game against a professional's game or a reference game, the results of which would be graphically stored for subsequent comparison with the player's game.

### BRIEF DESCRIPTION OF THE DRAWINGS

The invention will be more clearly understood from the following description of a preferred embodiment thereof, which is given by way of example only, with reference to the accompanying drawings, in which:

FIG. 1 is a block representation of a device according to the invention for recording parameters of a golf game,

FIG. 2 is a representation of a screen displayed by a display means of the device of FIG. 1,

FIG. 3 is a representation of a screen displayed by a display means of the device of FIG. 1,

FIG. 4 is a representation of a screen displayed by a display means of the device of FIG. 1,

FIG. 5 is a graphical representation of a screen displayed by a display means of the device of FIG. 1,

FIG. 6 is a graphical representation of a screen displayed by a display means of the device of FIG. 1,

FIG. 7 is a graphical representation of a screen displayed by a display means of the device of FIG. 1,

FIG. 8 is a graphical representation of a screen displayed by a display means of the device of FIG. 1,

FIG. 9 is a representation of a screen displayed by a display means of the device of FIG. 1,

FIG. 10 is a representation of another screen displayed by a display means of the device of FIG. 1,

FIG. 11 is a representation of another screen displayed by a display means of the device of FIG. 1,

FIGS. 12(a) to (c) are representations of a further screen displayed by a display means of the device of FIG. 1,

FIG. 13 is a view similar to FIG. 5 showing the device of FIG. 1 in use,

FIG. 14 is a flow chart of a routine of a computer programme of the device of FIG. 1,

FIG. 15 is a flow chart of another routine of the computer programme of the device of FIGS. 1, and

FIG. 16 is a flow chart of another routine of the computer programme of the device of FIG. 1.

### DETAILED DESCRIPTION OF THE INVENTION

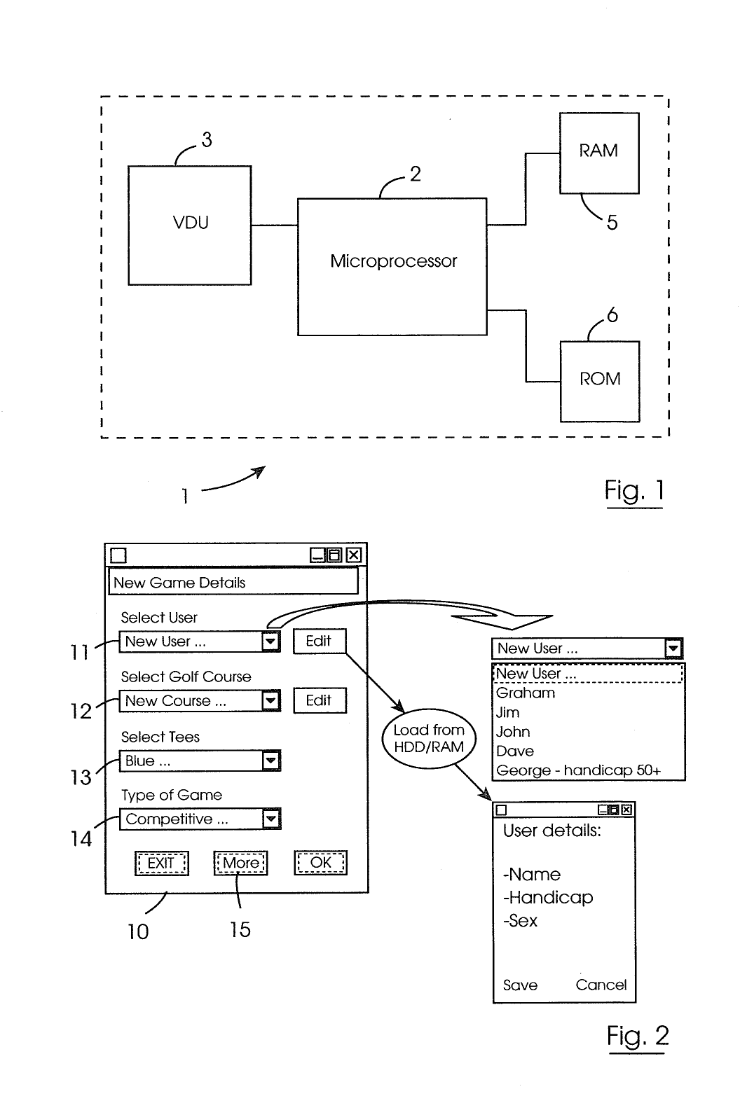

Referring to the drawings and initially to FIG. 1 there is illustrated a device according to the invention indicated generally by the reference numeral 1 for recording parameters of a golf game played by one or more players. The device 1 in this embodiment of the invention is a hand held device, and comprises a microprocessor 2 which controls the entire operation of the device 1. A display means provided by a visual display unit (VDU) 3 facilitates displaying graphical representations of one or more reference fairways and reference greens, and also for facilitating graphically indicating on the reference fairway and/or reference greens, positions indicative of locations taken up by a ball after respective shots, as will be described below. The VDU 3 also facilitates displaying in tabular form as will be described below scores achieved in a golf game. The VDU 3 may be a touch screen or otherwise, and if a touch screen the positions taken up by the ball after each shot may be entered by appropriately touching the screen at a location on a reference fairway or green displayed on the VDU 3 corresponding to the position of the ball after a shot on the fairway or green. Otherwise the positions taken up by the ball after each shot may be similarly indicated by a cursor on the screen, this is described in detail below. The microprocessor 2 reads the screen and computes the number of shots for each hole and the score for a game of golf.

A first storing means provided by a random access memory (RAM) 5 stores the number of shots taken for each hole played and the score of the game of golf played by the player for subsequent display on the VDU 3, or for subsequent downloading to an external computer, such as a club computer, for facilitating computing the results of a golf competition. The RAM 5 also stores the graphical representation of the reference fairway and green displayed for each hole together with the indicated positions which are indicative of the locations taken up by a ball after each shot between the tee and the hole of the respective fairways for subsequent display or for downloading.

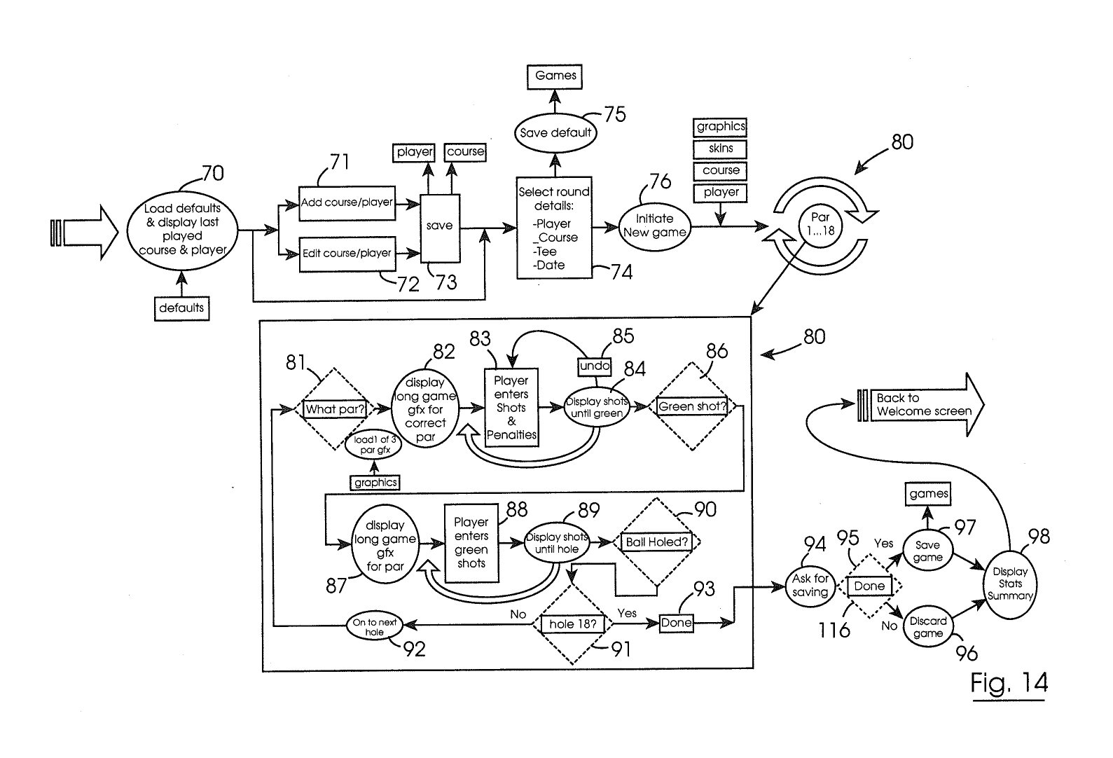

A second storing means, namely, a read-only memory (ROM) 6 stores a computer programme under which the microprocessor 2 operates and also stores the graphical representations of the reference fairways and the reference greens, which may be selectively called up by the microprocessor 2 for display on the VDU 3. The microprocessor 2 operates under the control of a computer programme, routines of which are described below with reference to FIGS. 14 to 16.

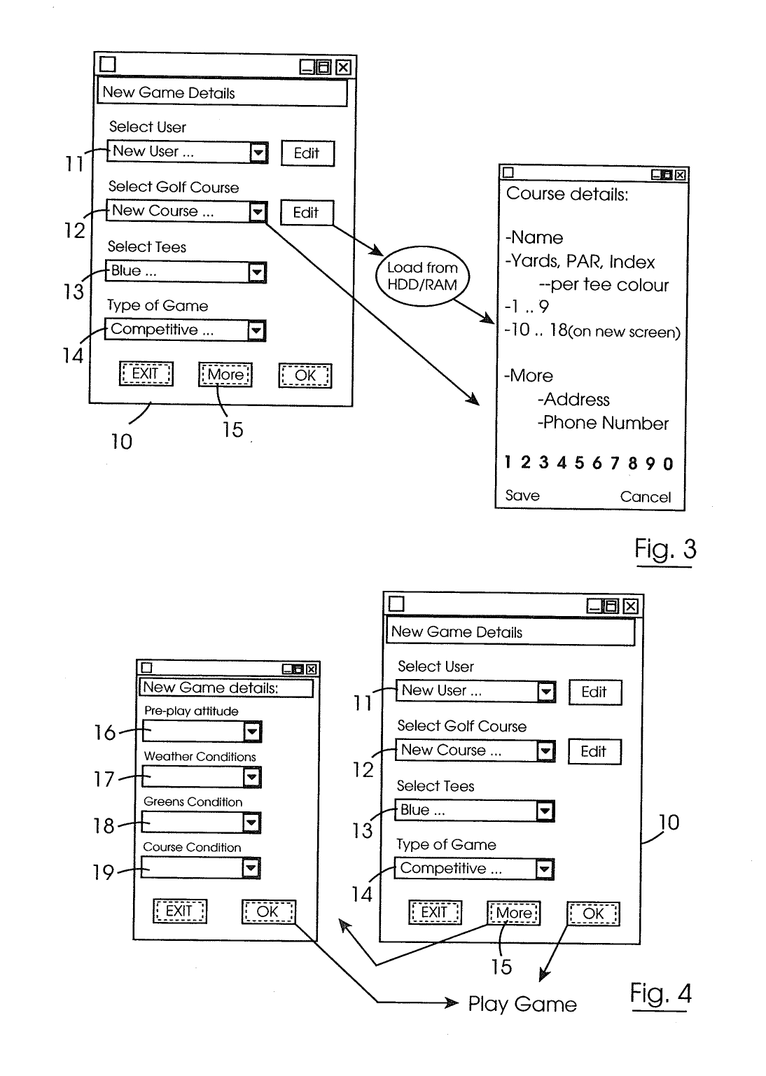

Referring now to FIGS. 2 to 4 a first screen 10 which is presented to a player on the VDU 3 prior to commencing a game of golf is illustrated which facilitates entry of data regarding the player and the course. A location 11 is provided on the screen 10 for facilitating inputting of particulars of the player or players who are to play a game of golf. A location 12 is provided on the screen 10 for facilitating entry of particulars of the golf course. A location 13 is provided on the screen 10 for permitting selection of the colour of tee to be used by each player. A location 14 is provided on the screen 10 for facilitating inputting of the type of game to be played, competitive or otherwise. An additional location 15 is provided which permits the selection of four subsidiary locations, namely, locations 16, 17, 18 and 19 from the screen 10, see FIG. 4. In location 16 each player may enter his or her condition prior to commencing the game of golf as one of three conditions, namely, excellent, good or poor. Location 17 permits entry of the weather conditions prevailing as the game is about to be played, and one of five conditions as follows may be selected:
excellent,
good,
average,
bad, and
terrible.

Locations 18 and 19 permit entry of the conditions of the greens and the course, and one of five conditions may be selected which are similar to those conditions which may be selected for the weather conditions. The data entered through the locations 11 to 19 on the screen 10 are stored in the RAM 5 and collated with the scores of the players of the game and recorded for subsequent reproduction on the VDU when reproducing the scores of the game, or for subsequent downloading along with the scores of the game.

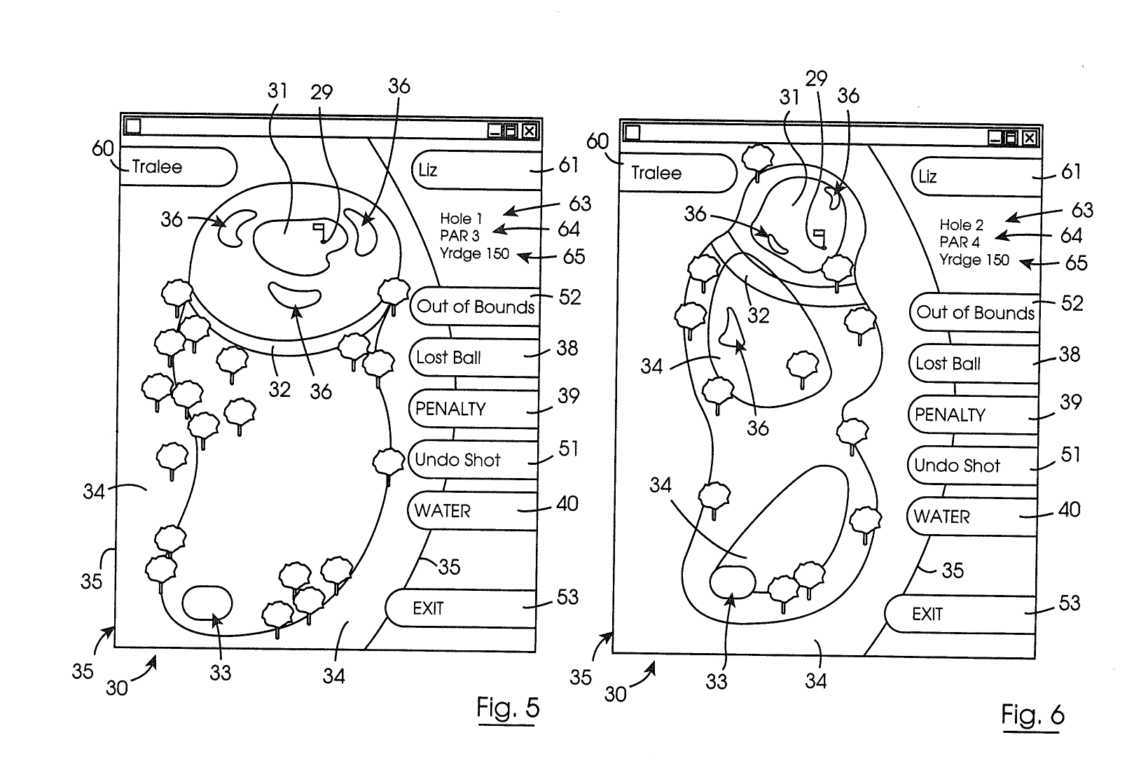

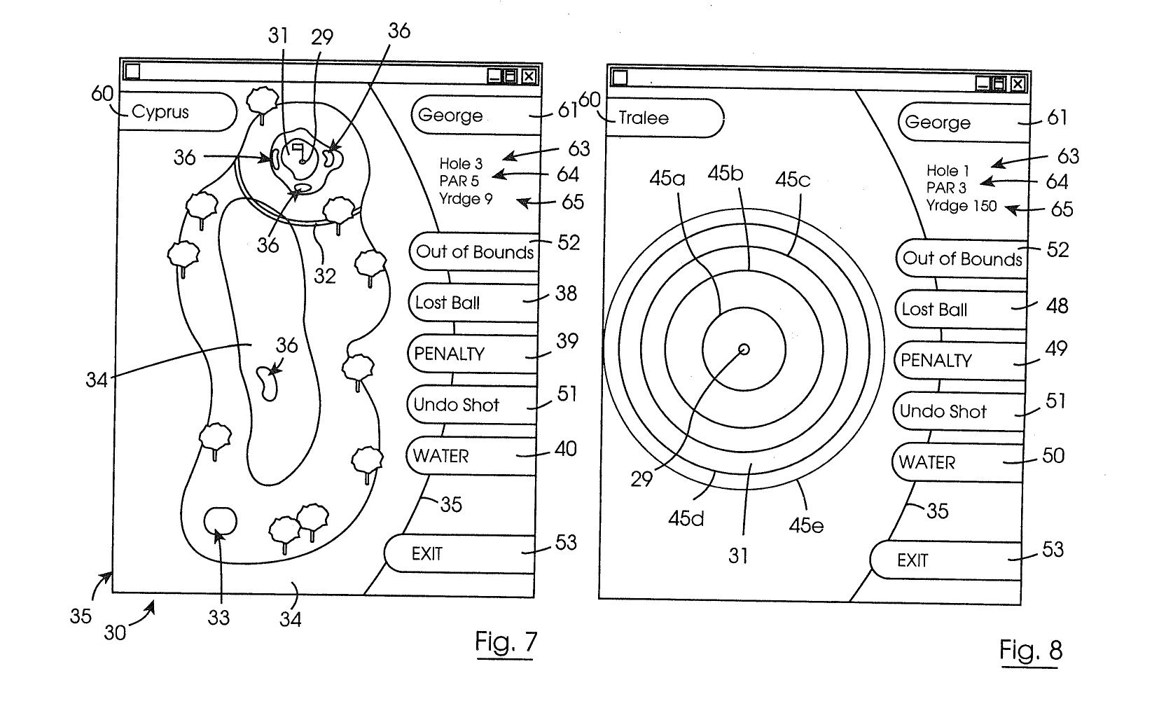

Referring now to FIGS. 5 to 7, there is illustrated three screens, which are selectively presented to each player as the game progresses, the screens are selected as will be described below by the par of the hole being played. Each screen comprises a reference fairway 30. The reference fairway 30 illustrated in FIG. 5 represents a par 3 hole, the reference fairway illustrated in FIG. 6 represents a par 4 hole, while the reference fairway illustrated in FIG. 7 represents a par 5 hole. Each reference fairway 30 also comprises a green 31 associates with the fairway 30, as well as a hole 29. A predetermined area 32 which is within fifty yards of the green 31 is also illustrated. By indicating on the screen that a player's ball landed in the area 32 a record of this is stored in the RAM 5. The tee off position 33 is graphically represented on the fairway 30. Areas of rough 34 in the reference fairways 30 both in a line between the tee 33 and the hole 29, and to the left and right thereof are graphically displayed on the reference fairways 30 for facilitating indicating if the ball after a shot landed in the rough in the centre, or to the left or right of the centre line between the tee 33 and the hole 29. Out of bound areas 35 are also graphically represented relative to the fairway 30 both to the left and right and to the end of the green 31, for similarly permitting indicating by touch or by the cursor on the screen if a ball landed out of bounds, and its general direction relative to a centre line between the tee 33 and the hole 29 after a shot. Sand bunkers 36 are also graphically represented for the same purpose. FIG. 13 illustrates how the path of the ball after each stroke is illustrated on the screen by a line 37 as the position 41 of the ball after each shot has been entered by touch or by the cursor on the screen.

A first input means comprising a first soft key 38 on the respective screens of FIGS. 5 to 7 facilitates inputting a message to indicate that a ball has been lost after a shot. A second input means comprising a second soft key 39 is provided on the screens for inputting a message indicating that a penalty has been incurred after a shot, and a third input means provided by a third soft key 40 is provided on the screen for facilitating inputting a message indicating that the ball landed in a water hazard after a shot.

Referring now to FIG. 8 an enlarged graphical representation of the green is illustrated for facilitating graphically indicating on the screen a position indicative of the location of a ball on the green after a shot. In this embodiment of the invention five bands 45 of predetermined radial width extend around the hole 29 at pitch circle diameters of predetermined radii. The band width of the first band 45a, namely, the band closest to the hole is at a radius of three yards from the hole 29. The next band 45b is at a radius of five yards from the hole 29, while the next band 45c is at a radius of seven yards from the hole 29, while the next band 45d is at a radius of ten yards from the hole 29, and the outermost band, namely, the band 45e is at a radius of fifteen yards from the hole 29. Accordingly, a player can indicate with the cursor on the screen a position within the respective bands indicative of the location within which the ball has landed or is played on the green.

First, second and third soft keys 48, 49 and 50 are also provided on the screen of FIG. 8 which are similar to the first, second and third soft keys 38, 39 and 40, respectively, of the screens of FIGS. 5 to 7. In addition, each of the screens of FIGS. 5 to 8 includes the following additional soft keys, namely, an undo shot key 51, which facilitates editing of the last shot, in other words repositioning the indicated position on the screen. A soft key 52 for facilitating indicating if the ball landed out of bounds, although, as discussed above this can be entered directly by touching the screen or by locating the cursor on the screen in an appropriate out of bound area 35. A soft key 53 for facilitating exiting from the screen is also provided. Soft keys 60 and 61 are provided on the respective screens of FIGS. 5 to 8 for calling up the title of the course being played and the name of the player. Locations 63 to 66 are provided on the respective screens of FIGS. 5 to 8 for indicating the hole being played, the par and the yardage of the hole. The microprocessor 2 under the control of the computer programme automatically increments the number of the hole as each hole has been played, however, an overwriting provision is made for overwriting the hole number.

As each hole is played the microprocessor 2 under the control of the computer programme computes the number of shots taken by the player from the tee 33 to the hole 29, and the number of shots is stored in the RAM 5. The microprocessor 2 also computes the number of shots to the green, and the number of shots on the green which are stored in the RAM 5 for each hole. The microprocessor 2 deducts the player's handicap from the score for each hole and stores the score for each hole and for the round in the RAM 5. The microprocessor 2 also compares the score for each hole against the par and index of the hole and also stores this information in the RAM 5. The scores for the front nine holes and the back nine holes are stored separately in the RAM 5. When a game has been completed the microprocessor 2 outputs the scores of each player for the round in tabular form which is displayed on the VDU 3.

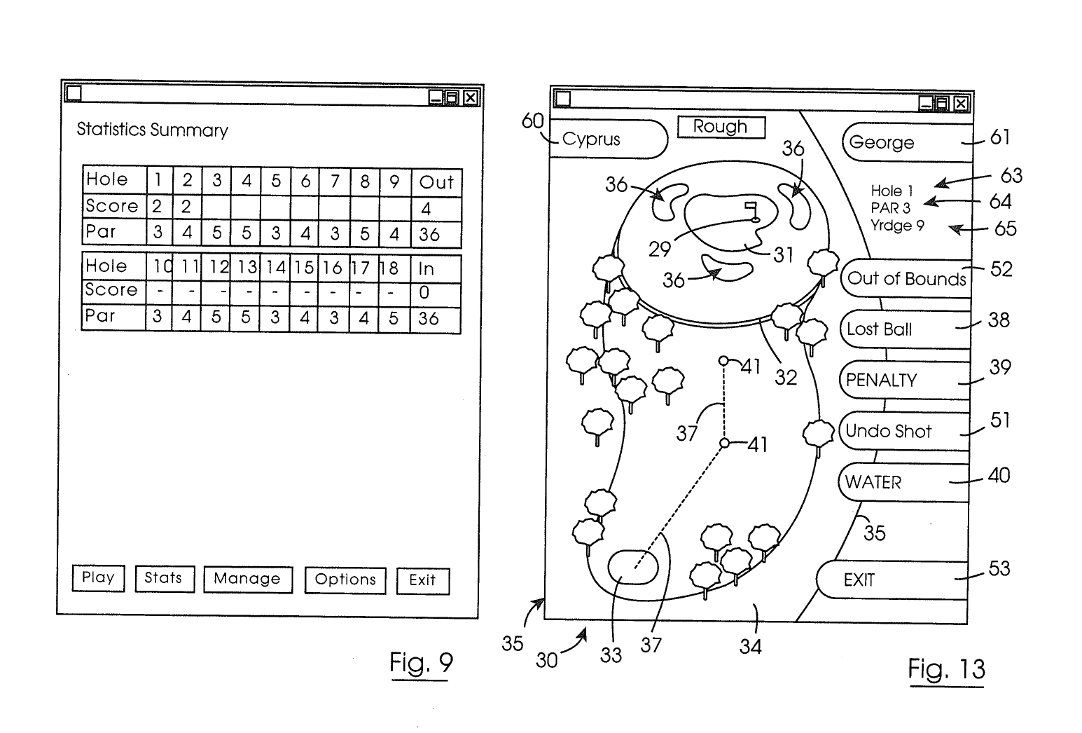

Referring in particular to FIG. 9 the format of a table in which the score is displayed on the VDU 3 is illustrated. As can be seen the score for each hole less the player's handicap is displayed, as well as the par and index for the hole. The total score for the front nine and the back nine holes are separately displayed. Needless to say, it will be appreciated that the scores using other golf conventions may also be displayed in appropriate tabular form. The microprocessor 2 under the control of the computer programme also stores the scores of a number of games played on the same course by the same player in the RAM 5, and under the control of the computer programme the microprocessor 2 selects the best score of the player on each hole, and displays in tabular form the results of a game using the best score on each hole achieved by the player. This score sheet is referred to as the score sheet of a “dream game”. Similarly, the microprocessor 2 under the control of the computer programme selects the worst scores achieved by the same player on the same course on each of the holes over a predetermined number of games and displays the score sheet of a game using the worst score for each hole, and the score displayed on such a score sheet is referred to as a “nightmare game”.

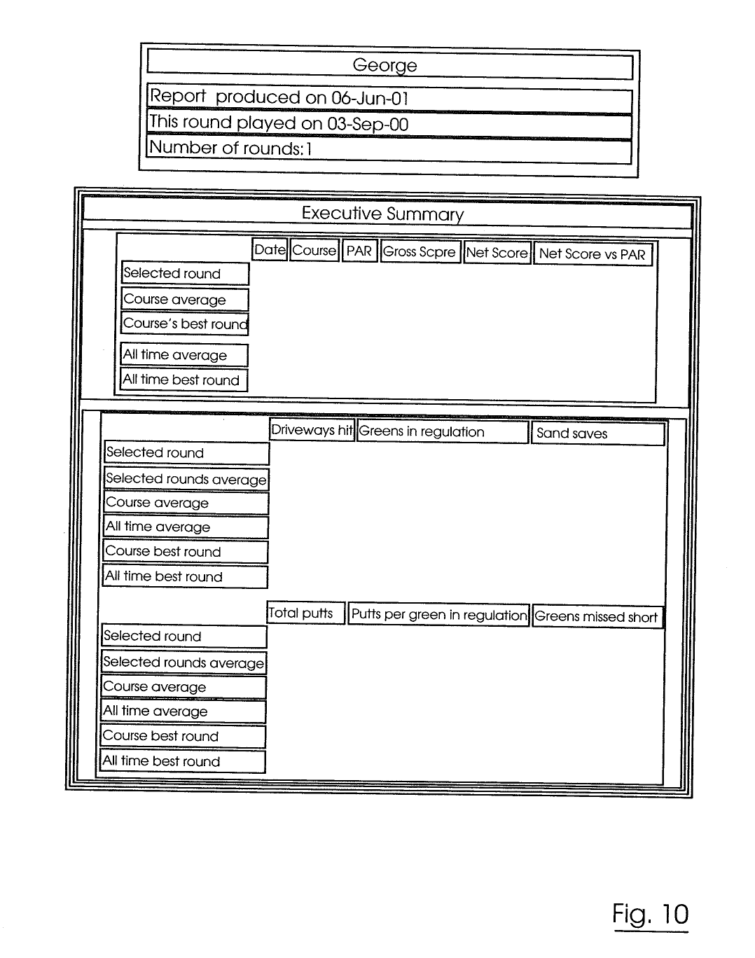

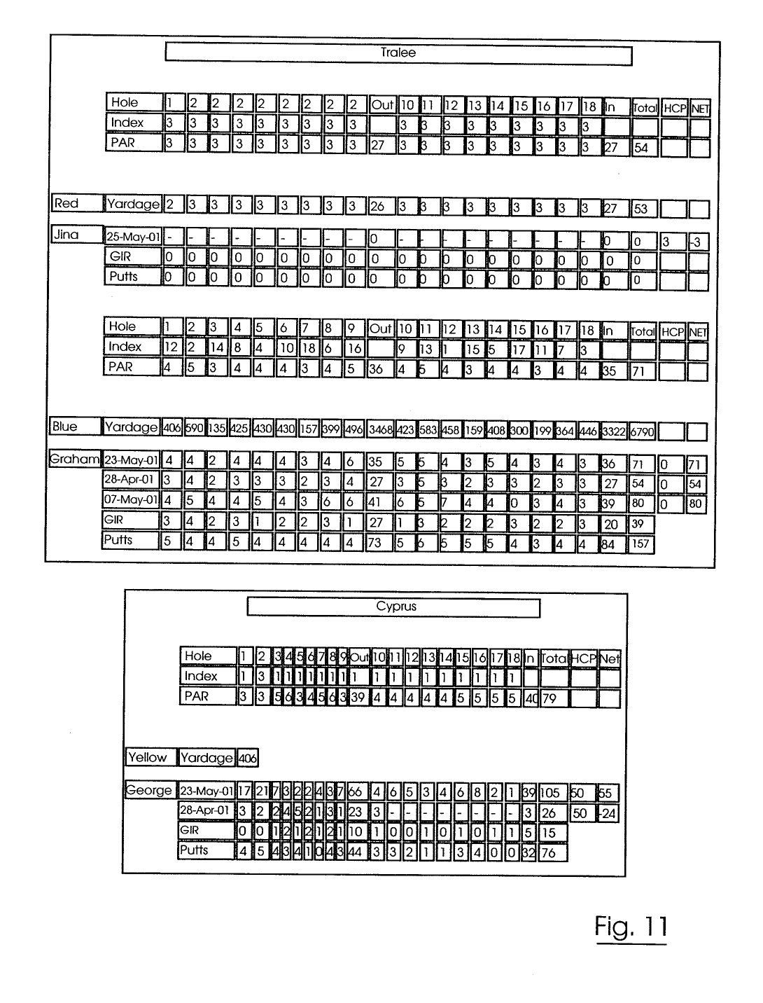

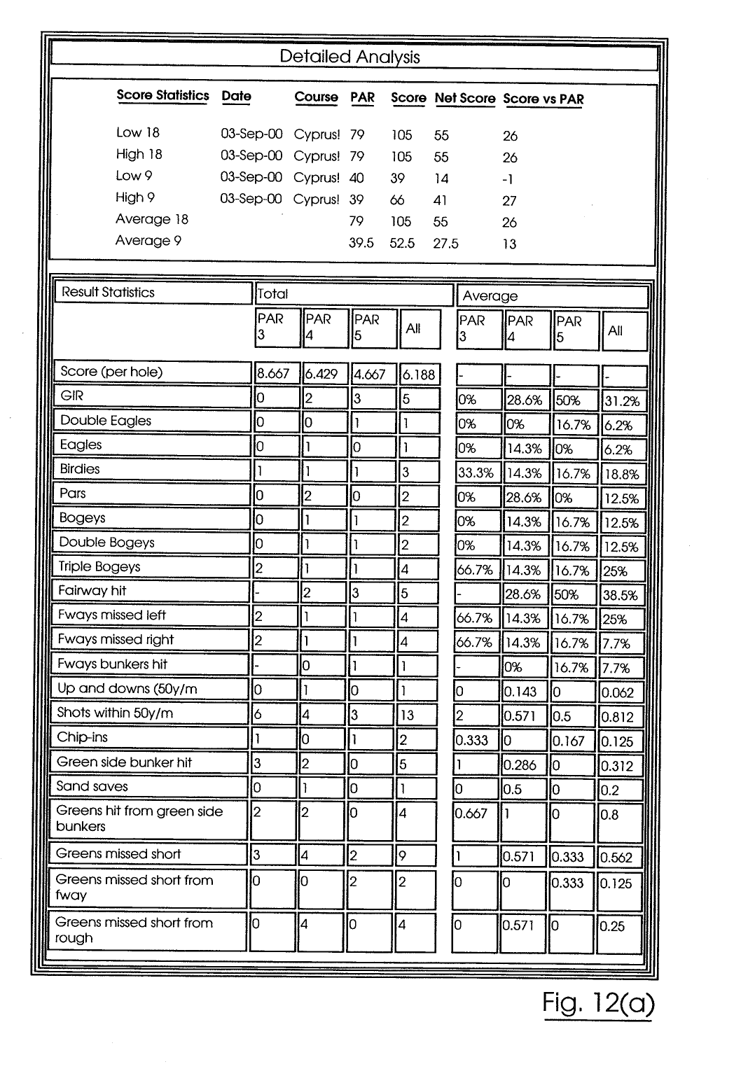

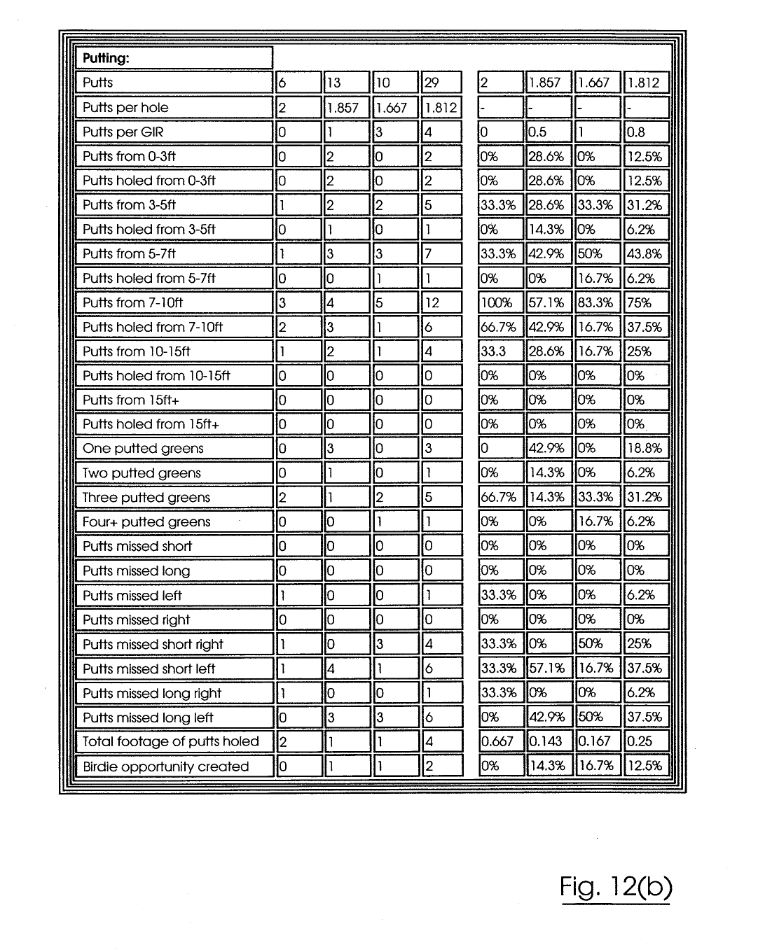

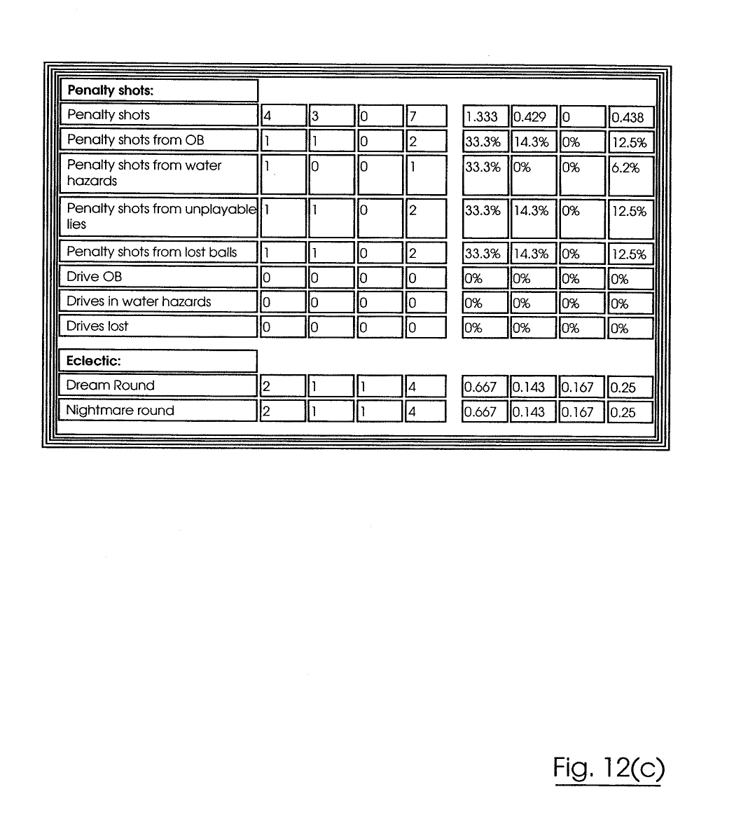

FIG. 10 illustrates a typical score sheet which is displayed on the VDU 3 if one wishes to display a number of games for comparison purposes. FIG. 11 shows another score sheet whereby scores from different courses, for example, in this case Tralee and Cyprus golf courses, are displayed on the VDU 3 and compared. FIGS. 12(a) to 12(c) illustrate a typical analysis which can be displayed on the screen.

The device can be used by a number of players playing in a competition, for example, by two players in a “two ball”, three in a “three ball”, four in a “four ball” and up to five players in a “five ball”. Each of the players can input their scores on each hole and the position of the ball after each shot can be entered through the screen for each player by graphically indicating the position on the respective graphical representations of the reference fairways and greens indicative of the location of the ball after each shot.

Referring now to FIG. 14, there is illustrated a routine of the computer programme for facilitating recording of the score and the positions of the ball on the fairways and greens in a game of golf played by a number of players. Block 70 of the routine commences the routine and loads defaults and displays the last played course and player. The routine permits the player to select the screen 10 illustrated in FIGS. 2 to 4, and if selected the routine moves to block 71 and/or 72. Block 71 permits a new course title and the names of the players to be entered. Block 72 permits the title of the course and the names of the players to be edited. The routine then moves to block 73 which saves the particulars entered of the course and the players in the RAM 5. The routine then moves to block 74 which again displays the screen 10 of FIGS. 2 to 4 and permits the particulars of the round of golf to be played, and the condition of the players, course, the tee colours and the date to be entered. Alternatively, block 74 could have been selected by the player directly from block 70. The routine then moves to block 75 which is a save default condition which saves particulars entered through the screen 10 while displayed under the control of block 74.

The routine then moves to block 75 which initiates the new game. The routine in initiating the new game under block 75 selects the appropriate reference fairway for the first tee or permits the player to select an appropriate reference fairway from the stored reference fairway. The routine also selects the skins, defines the course and the players of the game. The routine then moves to block 80 which is a loop subroutine and is described in detail with reference to the subroutine 80 also illustrated in FIG. 14.

The subroutine commences with block 81 which requests particulars of the par of the hole to be played, and moves to block 82, which selects and displays the reference fairways 30 of the appropriate par graphically on the VDU, which is loaded from the ROM by block 82. The subroutine then moves to block 83 which permits the player to enter his shots and penalties on the hole and moves to block 84 which permits the player to enter the position of the ball after each shot by touching the screen or positioning the cursor at a location on the fairway 30 or the green 31 corresponding to the position of the ball after each shot. Block 84 also displays the entered position of the ball and the path of the ball to the entered position. The path of the ball is illustrated by the line 37, see FIG. 13. Block 85 permits editing of the position of the last shot entered graphically on the fairway or green as the case may be. The subroutine then moves to block 86 which queries the player as to whether the last shot has landed on the green, and if so, the subroutine moves to block 87, otherwise the subroutine returns to block 83. Block 87 graphically displays an appropriate green such as the green 31 illustrated in FIG. 8. The subroutine moves to block 88 which permits the player to enter the location of the ball graphically on the green as already described with reference to block 84, and displays the entered position of the ball under block 89 on the screen. The subroutine returns to block 88 until the ball has been holed. Block 90 questions the player as to whether the ball has been holed, and if so, moves the subroutine to block 91 which queries if all eighteen holes of the game have been played. If not, the subroutine moves to block 92 which permits the next hole to be selected by returning the subroutine to block 81. On the other hand, if all eighteen holes have been played, the subroutine moves from block 91 to block 93 which confirms that the game is over and instructs the microprocessor 2 to compute the scores for the players of the game.

The subroutine then returns control of the microprocessor 2 to the routine under which the microprocessor was operating prior to entering the subroutine loop 80, and moves to block 94 which queries the player as to whether the game is to be saved or otherwise. Under block 95 if the player confirms that the game is to be discarded, the routine moves to block 96, which discards the game. If the game is to be saved, the routine moves to block 97 and saves the game in the RAM 5. After block 96 and 97 the routine moves to block 98 which displays a statistical summary of the game and returns control of the microprocessor 2 to the main computer.

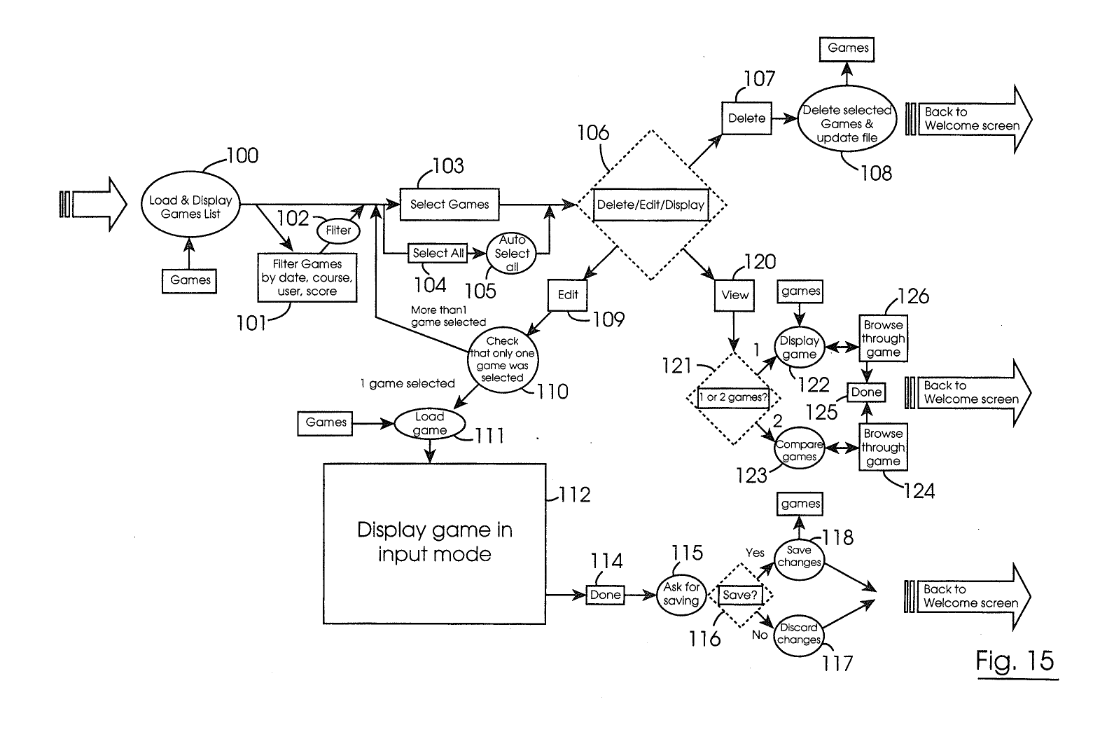

Referring now to FIG. 15, a flow chart of a routine of the computer programme which permits review of games already played and stored in the device 1 to be reviewed is illustrated. The routine commences with block 100 which displays a list of the games stored in the RAM 15. The routine may be directed by the player to move to block 101 which filters the games by date, course, user and score and moves through a filter block 102 to block 103 which permits the game to be selected. Alternatively, the routine may be moved to block 104 which permits all games to be selected and then moves to block 105 which provides for an automatic game selection. The routine then moves to block 106 which permits deleting, editing or displaying of a selected game. If delete is selected under block 106 the routine moves to block 107 which deletes the game, and then moves to block 108, which updates the file to remove particulars of the deleted game from the RAM 5. After block 108 the routine returns control of the microprocessor to the main computer programme. Should it be desired to edit the selected game, an edit request is entered under block 106 and the routine moves to block 109 which permits editing of the game. The routine then moves to block 110 which checks that only one game has been selected. If more than one game has been selected, the routine is returned from block 110 to block 103 or block 104, both of which have already been described. On the other hand, if only one game has been selected, the routine moves to block 111 which selects the game from the RAM 5 and moves to block 112 which displays the game in input mode and recommences with block 70 of the routine of FIG. 14. After editing has been completed the routine moves to block 114 which confirms that editing has been completed, and then moves to block 115, which requests the user to indicate if the edited game is to be saved or otherwise. Under block 116 the user indicates whether the game is to be saved or discarded and the routine moves appropriately to block 117 which discards the game or to block 118 which saves the game in the RAM 5. The routine moves from block 117 and 118 and returns control of the microprocessor to the main computer programme.

Returning now to block 106, if the player selects that the selected game is to be displayed under block 106, the routine moves to block 120 which provides for viewing of the game. The routine then moves to block 121 which queries as to whether one or two games are to be played. If one game is to be played, the routine moves to block 122 which displays the selected game. On the other hand, if two games are selected under block 121 the routine moves to block 123 which facilitates comparisons to be made between the two games. The routine then moves to block 124 and moves backwards and forwards between block 123 and block 124 to permit browsing and comparison of various aspects of the game. On the browsing and comparison being completed, the routine then moves to block 125 which returns control of the microprocessor to the main programme. On the other hand, if block 121 had selected just one game to be displayed, the game, as already discussed, is displayed under block 122 and the routine moves to block 126 which facilitates browsing through the game. On completion of browsing the routine moves to block 25, which has already been described.

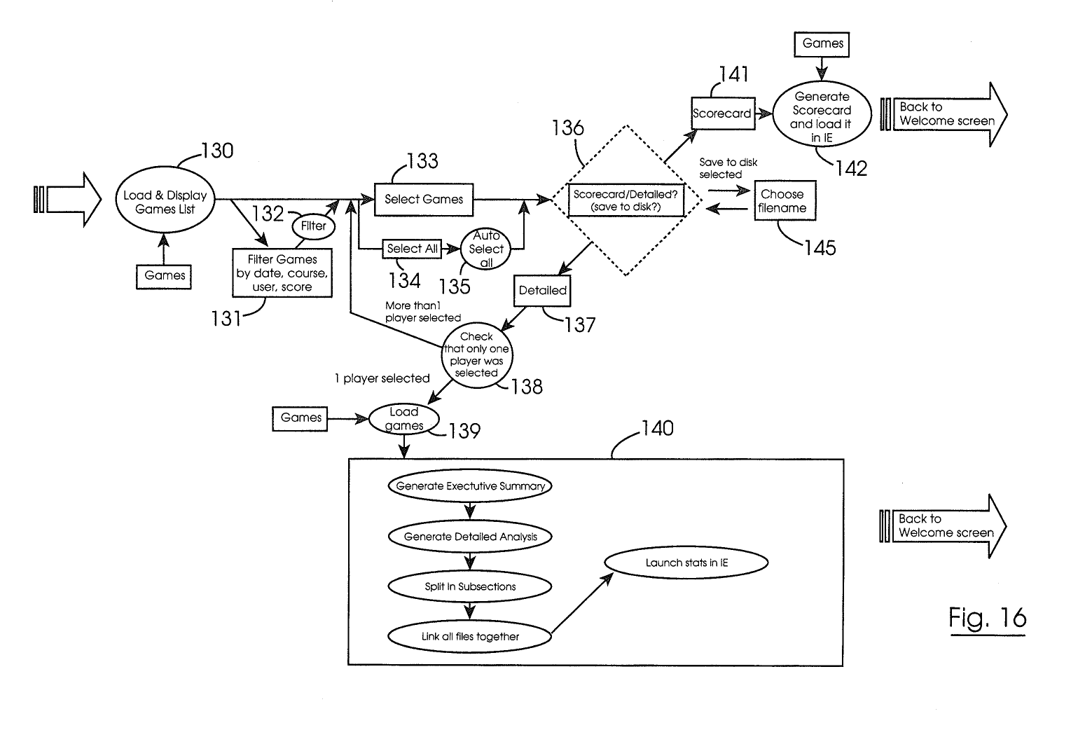

Referring now to FIG. 16, a routine which permits a player to analyse his or her performance in a game is illustrated. Block 130 commences the routine which lists the games which can be selected. This is similar to block 100 of the routine of FIG. 15. The routine of FIG. 16, as with the routine of FIG. 15, permits filtering of the games through block 131, 132 and then moves to block 133 which permits a game to be selected. Alternatively, the routine permits all games to be selected under block 134, and moves to block 135 which selects all games. The routine then moves from block 133 or block 135 to block 136 which queries a player as to whether the score card details are to be displayed and also if they are to be saved out on disk. If they are to be detailed, the routine moves to block 137 which details the score cards and moves to block 138 which checks if only one game has been selected. If more than one game has been selected, block 138 returns the routine to block 133 or 134. If only one game has been selected, the routine moves from block 138 to block 139 which loads the selected game from the RAM 15, and moves to block 140 which displays various aspects of the game on the VDU 3. The information which is displayed is a general executive summary, a general detailed analysis, analysis of games split in subsections, a link to all files is also provided, and statistics of the game may also be displayed. After block 140 the routine returns control of the microprocessor 2 to the main computer. On the other hand, if block 136 requested a score card to be displayed, the routine moves to block 141, which moves the routine to block 142, which generates the score card and loads it in an internet explorer format for ease of display and subsequent printing out, if so required. After block 142 the routine returns control of the microprocessor 2 to the main computer programme. If under block 136 it was requested that the selected game be saved on disk, the routine moves to block 145 which permits a file name to be chosen for the game and then saves the programme on disk and returns to block 136.

The main computer programme under which the microprocessor 2 is controlled controls the transfer of control of the microprocessor between the routines which have already been described. The main computer programme also carries out general housekeeping of the microprocessor which will be well known to those skilled in the art, and also includes a large number of subroutines for controlling the graphical representations of the fairways 30, and the greens 31, as well as the presentation of the scores in the various formats. Such subroutines will be well known to those skilled in the art. Additionally, the main computer programme also includes appropriate subroutines for reading data from the ROM 6 and the RAM 5 and for storing data and the graphical representations of the fairways and green for each hole played by each player in the ROM 5. Further, the main computer programme comprises appropriate subroutines for facilitating reading the location of the cursor or of a touch on the screen if the screen is provided by a touch screen for determining the indicated position of the ball on the screen. All such subroutines will be well known to those skilled in the art and further description should not be required.

The device according to the invention has the additional advantages that it permits ready display of any particular game played by one or more players. Many games by one or a number of players can be stored and recalled instantly. The games can be stored under any suitable classification system, for example, by name of person, course and date played, or by any other suitable means. A player may also use the device to enter a game played by a professional on a particular course, and compare his or her game with that of the professional.

While the device according to the invention has been described as being a hand held device, the device may be any other suitable device, and indeed, may be provided in the form of a computer, such as, for example, a personal computer. In which case, the computer would operate under the computer programme already described in similar fashion as the hand held device. Furthermore, it is envisaged that any or all the graphical representations of golf games stored in the hand held device may be downloaded onto any suitable type of computer, for example, a personal computer for comparison with other games downloaded, or other games stored in the personal computer, for editing and/or for any other purpose.

It is also envisaged that the device according to the invention may include a means for reading the wind speed and direction on the day a game of golf is being played, and may also include a means for reading the humidity and temperature on the day the golf game is being played. The computer programme would be adapted for reading and storing the wind speed and direction, the humidity and the temperature, and all such parameters would be stored in the first storing means, namely, the RAM 5.

1. A device for recording parameters of a golf game, characterised in that the device comprises a display means (3) for displaying graphically a representation of a reference fairway (30), a means for indicating on the reference fairway (30) a position (41) indicative of a location taken up by a ball after a shot, a reading means (2) for reading the indicated position (41), and a computing means (2) responsive to the reading means reading an input which indicates that a ball has been holed for summing the number of indicated positions (41) indicated on the reference fairway (30) for determining the number of shots from a tee to a hole, and a first storing means (5) for storing the determined number of shots from the tee to the hole.

2. A device as claimed in claim 1 characterised in that a second storing means (6) is provided for storing graphical representations of a plurality of reference fairways (30), the pars of the holes of which are different, and preferably, the graphical representations of the respective reference fairways (30) differ depending on the par of the hole, and advantageously, the means (3) for displaying the graphical representation of one of the reference fairways (30) is provided for selectively displaying a selected one of the reference fairways (30), and preferably, the display means (3) displays a graphical representation of respective selected ones of the reference fairways (30) for each of a number of holes to be played in the golf game.

3. A device as claimed in claim 1 characterised in that the computing means (2) computes the score of a round of golf, and the first storing means (5) stores the score of a round of golf, and preferably, the first storing means (5) stores the graphical representation of each reference fairway (30) displayed for the respective holes with the indicated positions (41) on the respective graphical representations of the reference fairways for each hole played, and preferably, the graphical representation of each reference fairway (30) comprises a representation of a rough location, and advantageously, the graphical representation of each reference fairway (30) comprises an out of bounds location, and preferably, the graphical representation of each reference fairway (30) comprises a sand bunker location, and preferably, at least some of the reference fairways (30) comprise a water hazard location.

4. A device as claimed in claim 1 characterised in that the reading means (2) reads the type of location in which the location taken up by the ball after a shot is indicated on the selected reference fairway (30), and preferably, the reading means (2) determines from the indicated position (41) the type of location in which the ball is indicated as being located after a shot, and advantageously, the reading means (2) determines from the indicated position (41) the lie of the ball to the left or right of a line joining the tee to the hole, and preferably, the graphical representation of each reference fairway (30) indicates an area between a green and the tee which is within a predetermined distance from the green, and the reading means (2) reads the indicated position (41) for determining if the indicated location of the ball is within the predetermined area.

5. A device as claimed in claim 2 characterised in that the second storing means (6) stores a graphical representation of at least one reference green (31) independently of the reference fairways, and preferably, the second storing means (6) stores a plurality of graphical representations of reference greens (31), and the respective reference greens (31) are stored in the second storing means (6) cross-referenced with corresponding reference fairways (30), and advantageously, the display means (3) selectively displays a graphical representation of a reference green (31) corresponding to each reference fairway (30) displayed, and preferably, the display means (3) displays a reference green (31) independently of each reference fairway (30), and advantageously, the display means (3) displays a reference green (31) corresponding to a reference fairway (30) independently of the reference fairway (30), and preferably, the graphical representation of each reference green (31) is provided with a plurality of bands (45) of predetermined radial distance from and extending around a hole on the reference green (31) for defining predetermined distances from the hole, and advantageously, the means for indicating the position indicative of a location taken up by a ball is provided for indicating the position relative to the hole taken up by the ball on the selected reference green (31), and preferably, the means for indicating the position indicative of a location taken up by a ball after a shot on the selected one of the selected reference fairway (30) or the selected reference green (31) is provided by a cursor, and preferably, the visual display means comprises a touch sensitive screen, and advantageously, the means for indicating the position indicative of a location taken up by a ball after a shot on the selected one of the selected reference fairway (30) or the selected reference green (31) is provided by a means for reading the position on the screen on which the screen is externally touched.

6. A device as claimed in claim 1 characterised in that a first input means is provided for inputting a message indicating a lost ball, and preferably, a second input means is provided for inputting a message indicating a penalty, and advantageously, a third input means is provided for indicating that the position taken up by a ball after a shot is within a water hazard, and preferably, the computing means is responsive to the first, second and third input means for computing the score of a round of golf.

7. A device as claimed in claim 1 characterised in that a data input means is provided for facilitating selective inputting of particulars of any one of the following characteristics of a player about to play a golf game, and of the golf course on which the golf game is to be played, namely,
the handicap of the player,
parameters of the course,
particulars of the tees being played, course conditions on the day the game is being played,
weather conditions on the day the game is being played, and
condition of the player on the day the game is being played.

8. A device as claimed in claim 7 characterised in that the data input means permits inputting of the number of holes in the golf course, the yardage of each hole, the par of each hole and the index of each hole, and preferably, the first storing means (5) stores data inputted through the data input means, and advantageously, the computing means (2) computes the score for each hole less the handicap of the player.

9. A device as claimed in claim 1 characterised in that the computing means (2) compares the player's score for each hole against the par and/or index of the hole, and preferably, an output means is provided for outputting the score for each hole played and the score for the round played, and preferably, the output means facilitates outputting the score of the front nine holes and the back nine holes separately of each other, and advantageously, the output means interfaces with the display means for displaying the respective scores on the display means, and preferably, the scores are displayed on the display means in tabular form.

10. A device as claimed in claim 1 characterised in that the computing means (2) is adapted for selecting the holes of each of the holes played on a particular golf course over a number of games on which the player achieved the best hole scores, and displaying the scores of the selected ones of the holes in tabular form as a “dream game”, and preferably, the computing means (2) is adapted for selecting the holes of each of the holes played on a particular golf course over a number of games on which the player achieved the worst hole scores, and displaying the scores of the selected ones of the holes in tabular form as a “nightmare game”.

11. A device as claimed in claim 1 characterised in that the device is a hand held device, and preferably, the device comprises an interface means for interfacing the device with an external computer for downloading data in respect of each game to the external computer.

12. A method for recording parameters of a golf game, characterised in that the method comprises the steps of displaying a graphical representation of a reference fairway (30) on a visual display means (3), indicating on the reference fairway (30) a position (41) indicative of a location taken up by a ball after a shot, reading the indicated position (41) by a reading means (2), summing the number of indicated positions (41) indicated on the reference fairway (30) for determining the number of shots from a tee to a hole in a computing means (2), and storing the determined number of shots from the tee to the hole in a first storing means (5).

13. A method as claimed in claim 12 characterised in that the graphical representation of each reference fairway (30) displayed for the respective holes with the indicated positions (41) on the respective graphical representations of the reference fairways for each hole played is stored in the first storing means (5), and preferably, a second storing means (6) is provided for storing graphical representations of a plurality of reference fairways (30), the pars of the holes of which are different, and preferably, the graphical representations of the respective reference fairways (30) differ depending on the par of the hole, and advantageously, the means (3) for displaying the graphical representation of one of the reference fairways (30) is provided for selectively displaying a selected one of the reference fairways (30), and preferably, the display means (3) displays a graphical representation of respective selected ones of the reference fairways (30) for each of a number of holes to be played in the golf game.

14. A method as claimed in claim 12 characterised in that the score of a round of golf is computed in the computing means (2), and the first storing means (5) stores the score of a round of golf, and preferably, the graphical representation of each reference fairway (30) comprises a representation of a rough location, and preferably, the graphical representation of each reference fairway (30) comprises an out of bounds location, and advantageously, the graphical representation of each reference fairway (30) comprises a sand bunker location, and preferably, at least some of the reference fairways (30) comprise a water hazard location.

15. A method as claimed in claim 12 characterised in that the reading means (2) reads the type of location in which the location taken up by the ball after a shot is indicated on the selected reference fairway (30), and preferably, the reading means (2) determines from the indicated position (41) the type of location in which the ball is indicated as being located after a shot, and advantageously, the reading means (2) determines from the indicated position (41) the lie of the ball to the left or right of a line joining the tee to the hole, and preferably, the graphical representation of each reference fairway (30) indicates an area between a green and the tee which is within a predetermined distance from the green, and the reading means (2) reads the indicated position (41) for determining if the indicated location of the ball is within the predetermined area.

16. A method as claimed in claim 13 characterised in that the second storing means (6) stores a graphical representation of at least one reference green (31) independently of the reference fairways, and preferably, the second storing means (6) stores a plurality of graphical representations of reference greens (31), and the respective reference greens (31) are stored in the second storing means (6) cross-referenced with corresponding reference fairways (30), and advantageously, the display means (3) selectively displays a graphical representation of a reference green (31) corresponding to each reference fairway (30) displayed, and preferably, the display means (3) displays a reference green (31) independently of each reference fairway (30), and advantageously, the display means (3) displays a reference green (31) corresponding to a reference fairway (30) independently of the reference fairway (30), and preferably, the graphical representation of each reference green (31) is provided with a plurality of bands (45) of predetermined radial distance from and extending around a hole on the reference green (31) for defining predetermined distances from the hole.

17. A method as claimed in claim 16 characterised in that the means for indicating the position indicative of a location taken up by a ball is provided for indicating the position relative to the hole taken up by the ball on the selected reference green (31), and preferably, the means for indicating the position indicative of a location taken up by a ball after a shot on the selected one of the selected reference fairway (30) or the selected reference green (31) is provided by a cursor.

18. A method as claimed in claim 16 characterised in that the visual display means comprises a touch sensitive screen, and preferably, the means for indicating the position indicative of a location taken up by a ball after a shot on the selected one of the selected reference fairway (30) or the selected reference green (31) is provided by a means for reading the position on the screen on which the screen is externally touched, and advantageously, a first input means is provided for inputting a message indicating a lost ball, and preferably, a second input means is provided for inputting a message indicating a penalty, and advantageously, a third input means is provided for indicating that the position taken up by a ball after a shot is within a water hazard, and preferably, the computing means is responsive to the first, second and third input means for computing the score of a round of golf.

19. A method as claimed in claim 12 characterised in that a data input means is provided for facilitating selective inputting of particulars of any one of the following characteristics of a player about to play a golf game, and of the golf course on which the golf game is to be played, namely,
the handicap of the player,
parameters of the course,
particulars of the tees being played, course conditions on the day the game is being played,
weather conditions on the day the game is being played, and
condition of the player on the day the game is being played.

20. A method as claimed in claim 19 characterised in that the data input means permits inputting of the number of holes in the golf course, the yardage of each hole, the par of each hole and the index of each hole, and preferably, the first storing means (5) stores data inputted through the data input means.

21. A method as claimed in claim 19 characterised in that the computing means (2) computes the score for each hole less the handicap of the player, and preferably, the computing means (2) compares the player's score for each hole against the par and/or index of the hole, and advantageously, an output means is provided for outputting the score for each hole played and the score for the round played, and preferably, the output means facilitates outputting the score of the front nine holes and the back nine holes separately of each other, and advantageously, the output means interfaces with the display means for displaying the respective scores on the display means, and preferably, the scores are displayed on the display means in tabular form.

22. A method as claimed in claim 12 characterised in that the computing means (2) is adapted for selecting the holes of each of the holes played on a particular golf course over a number of games on which the player achieved the best hole scores, and displaying the scores of the selected ones of the holes in tabular form as a “dream game”, and preferably, the computing means (2) is adapted for selecting the holes of each of the holes played on a particular golf course over a number of games on which the player achieved the worst hole scores, and displaying the scores of the selected ones of the holes in tabular form as a “nightmare game”.
